(19) United States
(12) Patent Application Publication
(10) Pub. No.: US 2022/0120912 A1
(43) Pub. Date: Apr. 21, 2022

(54) INTELLIGENT GEOSPATIAL GRID ENGINE AND WARNING SYSTEM

(71) Applicant: Bank of America Corporation, Charlotte, NC (US)

(72) Inventors: Lekha Bollinani, Chennai (IN); Lakshmi Priya, Chennai (IN); Ramya Gangathara Rao, Chennai (IN)

(21) Appl. No.: 17/071,334

(22) Filed: Oct. 15, 2020

(51) Int. Cl. G01S 19/01; G06Q 20/40; G06Q 20/42; G06Q 30/00; H04W 12/06; H04L 29/06; H04W 12/00

(52) U.S. Cl. CPC G01S 19/01; G06Q 20/4015; G06Q 20/42; H04W 12/00503; H04W 12/06; H04L 63/102; G06Q 30/0185

(57) ABSTRACT

An apparatus receives a transaction request comprising a pair of latitude and longitude coordinates for where a transaction is being attempted by a user. The apparatus determines that the latitude and longitude coordinates from the transaction request are outside of a first region comprising a first plurality of points and outside of a second region comprising a second plurality of points. The points in the first and second regions comprise latitude and longitude coordinates for a location where a user visited. The second region does not overlap the first region. The apparatus tags the transaction request as anomalous. The apparatus generates an alert requesting that the user confirm whether the second transaction should be authenticated. The apparatus also transmits the alert to a first user device identified in a user account profile.

### TECHNICAL FIELD

This disclosure relates generally to control systems for error detection. More specifically, this disclosure relates to an intelligent geospatial grid engine and warning system.

### BACKGROUND

Malicious actors use a variety of methods to obtain user account information without authorization. For example, such malicious actors may use card skimming devices installed at card readers to save otherwise private data like a credit or debit card number. Malicious actors may then use that information to create duplicate cards that can then be used to obtain funds from the card's rightful user without authorization. Often, these unauthorized account uses are difficult to detect. Computer systems processing transactions initiated at a card reader or online do not analyze anything other than the user's credentials. If those credentials are compromised, then the processing systems will allow such transactions to occur.

Identification of unauthorized account use relies on the users finding such activity and reporting it. This leaves the user and the institution open to continuing attack from the malicious entity.

### SUMMARY OF THE DISCLOSURE

According to one embodiment, an apparatus for warning about security breaches comprises a memory and a hardware processor. The memory is configured to store a geospatial grid profile for a user and a user account profile. The geospatial grid profile comprises an identification of a first region and a second region. The first region comprises a first plurality of points that each comprise latitude and longitude coordinates for a location where a user visited. The second region comprises a second plurality of points that each comprise latitude and longitude coordinates for a location where the user visited. In one embodiment, the second region does not overlap the first region. The hardware processor is configured to receive a transaction request that includes a pair of latitude and longitude coordinates for where a transaction is being attempted by the user. The hardware processor is also configured to determine that the latitude and longitude coordinates from the transaction request are outside of the first and second regions. The hardware processor is then configured to tag the transaction request as anomalous. Further, the hardware processor is configured to generate an alert requesting that the user confirm whether the transaction should be authenticated. The hardware processor is then configured to transmit the alert to the first user device identified in the user account profile.

Certain embodiments provide one or more technical advantages. As an example, an embodiment improves the security of digital transactions by generating geospatial grids for each account holder so that future transactions purportedly completed by the account holder can be analyzed for authenticity. The disclosed systems and methods enable a cohesive view of user movement and transaction patterns derived from a variety of data sources. For example, the disclosed systems and methods can integrate data from social media posts as well as credit card transaction info to form a geospatial grid. Additionally, some embodiments can warn users of potential security breaches through multiple communication points through the internet of things.

The system described in this disclosure may be integrated into a practical application of an intelligent geospatial grid engine and warning system. For example, the disclosed system may be integrated into a transaction verifier. Additionally, the disclosed system may be used to contact account holders across multiple devices to ensure that warning messages are received and to decline unauthorized transactions. Each of these practical applications can conserve network bandwidth and computer resources.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of the present disclosure, reference is now made to the following description, taken in conjunction with the accompanying drawings and detailed description, wherein like reference numerals represent like parts:

FIG. 1 is a schematic diagram of an example warning system that uses an intelligent geospatial grid engine;

FIG. 2A illustrates part of an example of a geospatial grid profile;

FIG. 2B is an expanded view of part of the example geospatial grid profile illustrated in FIG. 2A;

FIG. 2C is an expanded view of another part of the example geospatial grid profile illustrated in FIG. 2A; and

FIG. 3 is a flowchart of an example method for warning about security breaches using the system of FIG. 1.

### DETAILED DESCRIPTION

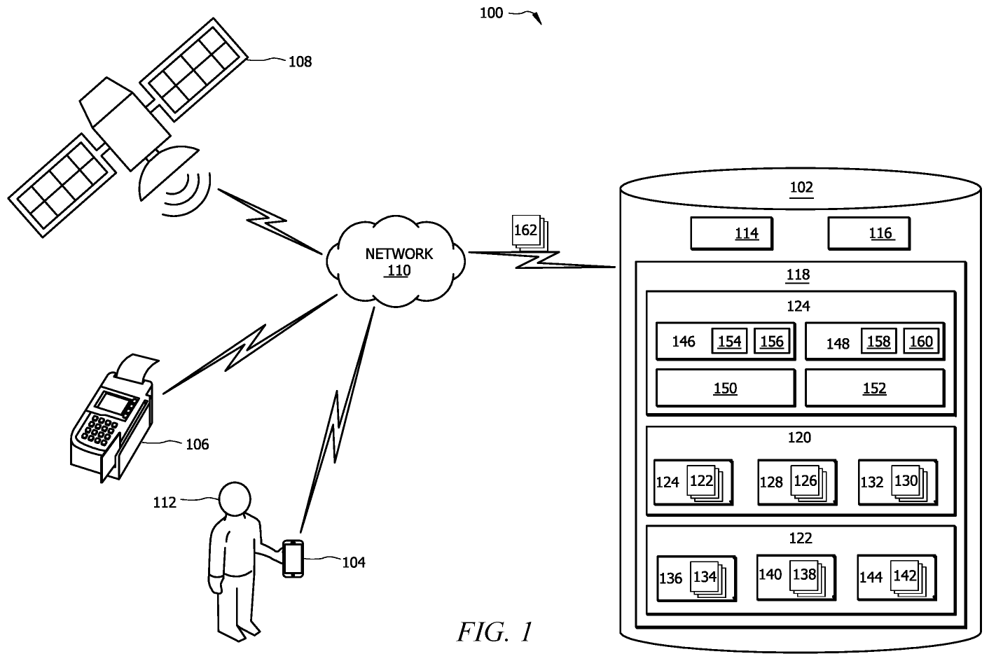

Embodiments of the present disclosure and its advantages are best understood by referring to FIGS. 1-3 of the drawings, like numerals being used for like and corresponding parts of the various drawings.

### System Overview

FIG. 1 is a schematic diagram of an example warning system 100 that uses an intelligent geospatial grid engine. The example warning system 100 is generally configured to collect user data and generate a geospatial grid of the user's transaction behavior. The warning system 100 is also generally configured to analyze incoming transaction requests for anomalous behavior indicating that an account might be compromised by a malicious actor. The predictive capabilities of the example warning system 100 provides a mechanism for entities to detect such malicious behavior without the user having to review every recorded transaction. Additionally, the improved detection times enabled by the disclosed warning system 100 reduce the frequency and duration of security breaches.

In one embodiment, the warning system 100 comprises a warning server 102, user device 104, transaction point 106, satellite 108, and network 110. This disclosure contemplates network 110 being any suitable network operable to facilitate communication between the components of the system 100. Network 110 may include any interconnecting system capable of transmitting audio, video, signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Satellite 108 is generally configured to gather data regarding the location of a user 112. The satellite 108 may be configured to collect geolocation data (i.e., gps coordinates) of a user device 104 and transmit that data to the warning server 102. The satellite 108 may also be configured to use photos or video to track the location of the user 112.

Transaction point 106 is any suitable device at a location where a user 112 attempts to electronically perform a transaction. For example, the transaction point 106 may be a card reader where user 112 tries to use a credit or debit card to purchase goods or services. The transaction point 106 may also be an automated teller machine (ATM). In other embodiments, the transaction point 106 is a suitable device at a virtual location rather than a physical card reader. For example, transaction point 106 may be a computer or processor associated with an online store front where user 112 uses a card or account identifier to pay for goods or services over the internet.

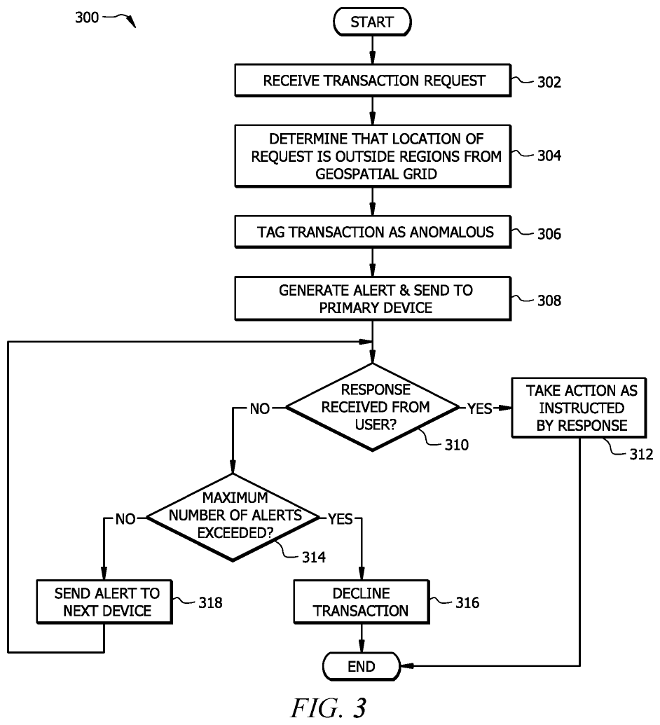

User device 104 is any smart device capable of receiving data from the warning server 102. For example, as illustrated in the example warning system 100, the user device 104 may be a smart phone. The user device 104 may also be a tablet, a personal computer, a laptop, a personal digital assistant, or any other device capable of wireless or wired communication. This also includes any Internet of Things (IOT) capable device, such as smart refrigerators, smart speakers, and other “smart” appliances. The role of smart device 104 is explained further in FIG. 3.

### Warning Server

An example warning server 102 includes processor 114, network interface 116, and memory 118. The processor 114 comprises one or more processors operably coupled to the memory 118. The processor 114 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 114 may be a programmable logic device, a microcontroller, a microprocessor, or any suitable combination of the preceding. The one or more processors are configured to process data and may be implemented in hardware or software. For example, the processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

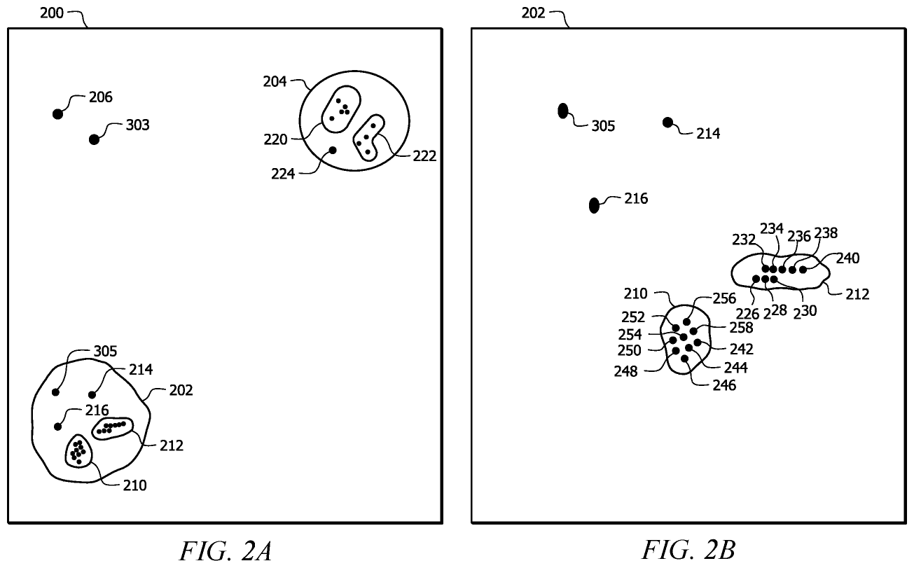

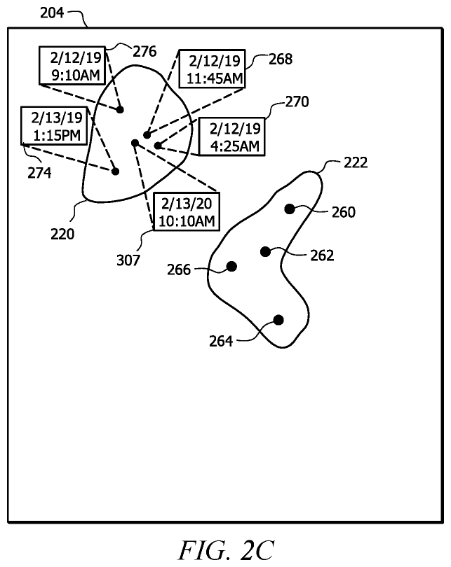

The one or more processors 114 are configured to implement a grid building engine 120 and an alert generation engine 124. For example, the one or more processors 114 are configured to execute one or more sets of instructions 122 to implement aggregator module 124, one or more sets of instructions 126 to implement compression module 128, and one or more sets of instruction 130 to implement grid generation module 132. The one or more processors 114 are also configured to execute one or more sets of instructions 134 to implement classification module 136, one or more sets of instructions 138 to implement anomaly tagging module 140, and one or more sets of instructions 142 to implement user confirmation module 144. In this way, processor 114 may be a special purpose computer designed to implement the functions disclosed herein. In an embodiment, the grid building engine 120 and alert generation engine 122 are implemented using logic units, FPGAs, ASICs, DSPs, or any other suitable hardware. For example, the aggregator module 124, compression module 128, and grid generation module 132 may perform any of the steps described along with FIG. 2. The classification module 136 may be configured to perform steps 302-304 of a method 300 as described in FIG. 3. Anomaly tagging module 140 may be configured to perform step 306 of a method 300 as described in FIG. 3. User confirmation module 144 may be configured to perform steps 308-318 of a method 300 as described in FIG. 3.

The network interface 116 is configured to enable wired and/or wireless communications. The network interface 116 is configured to communicate data between the warning server 102 and other devices (e.g., user device 104), systems, or domains. For example, the network interface 116 may comprise a WIFI interface, a LAN interface, a WAN interface, a modem, a switch, or a router. The processor 114 is configured to send and receive data using the network interface 116. The network interface 116 may be configured to use any suitable type of communication protocol as would be appreciated by one of ordinary skill in the art.

Memory 118 comprises one or more disks, tape drives, or solid-state drives, and may be used as an over-flow data storage device, to store programs when such programs are selected for execution, and to store instructions and data that are read during program execution. The memory 118 may be volatile or non-volatile and may comprise read-only memory (ROM), random-access memory (RAM), ternary content-addressable memory (TCAM), dynamic random-access memory (DRAM), and static random-access memory (SRAM).

The memory 118 is operable to store instructions grid building engine 120, alert generation engine 122, and user account profiles 124. The grid building engine 120 comprises instructions 122 for implementing aggregator module 124, instructions 126 for implementing compression module 128, and instructions 130 for implementing grid generation module 132. Details about the role of grid building engine 120 is discussed in further detail along with FIG. 2. Alert generation engine 122 comprises instructions 134 for implementing classification module 136, instructions 138 for implementing anomaly tagging module 140, and instructions for implementing user confirmation module 144. Operation of alert engine 122 and its constituent modules is detailed in FIG. 3. Each registered user 112 has their own user account profile 124. A user account profile 124 may comprise a list of user devices 146 associated with the user 112 where the user 112 may receive alerts 162, with an indication of a preferred format for receiving alerts on each device, a list of contact info 148, location data 150 of past transactions involving the user 112, and a list of social media accounts 152 associated with the user 112. The list of user devices 146 may further comprise an internet protocol (IP) address 154 and an International Mobile Equipment Identity (IMEA) 156 for each device. The contact info 148 may further comprise an email address 158 associated with the user 112 and a phone number 150 associated with the user 112.

### Geospatial Grid Assembly

FIGS. 2A-B illustrate a geospatial grid 200 that is generated by grid building engine 120 for a user 112. To generate a geospatial grid 200, the warning server 102 receives a plurality of geolocation data regarding the whereabouts of user 112 and financial transactions made by user 112. For example, satellite 108 may be configured to track the movements of user 112 via a camera and send latitude and longitude coordinates for the path of movement of user 112 to warning server 102. The transaction point 106 may provide location data (latitude and longitude coordinates, street address, IP address, etc.) for where user 112 conducts a financial transaction. The user device 104 may also be used to collect location data of the user 112. For example, the user 112 may elect to allow a mobile application to collect location data and track the whereabouts of the user 112. Social media outlets that user 112 may access from user device 104 may also provide location data. For example, when the user 112 posts a photograph to a social media outlet, the server 102 can deduce the location at which the photo was taken to determine where the user 112 is at the time of the social media post.

Aggregator module 124 takes all the location data received for the various users 112 and sorts them amongst the users 112 to begin building a geospatial grid 200 for each user 112. Next, the compression module 128 filter's the data points for each user 112 to eliminate data that may no longer be accurate or relevant. For example, the compression module 128 may determine that the user 112 completed a change of address form with the entity controlling warning server 102 and may eliminate data points that are in proximity to the old address. The compression module 128 may also eliminate data points if they are associated with an expired account or card.

Finally, the grid generation module 132 constructs a geospatial grid 200 for each user 112. FIGS. 2A-C provide a visual representation of a geospatial grid 200, but the geospatial grid 200 is not necessarily a viewable map. The geospatial grid 200 may be a mathematical representation of the various data points that can be used for computational analysis. FIG. 2 comprise a plurality of points that each comprise a pair of latitude and longitude coordinates for a location where the user 112 has visited or participated in a financial transaction. For example, the view of the geospatial grid 200 in FIG. 2A illustrates a first region 202 with a plurality of points and a second region 204. The first region 202 may comprise the area in which user 112 lives and works while the second region 204 may comprise an area where the user 112 visited for vacation. FIG. 2A also illustrates a data point 206 that lies outside of the first region 202 and second region 204. This data point 206 may represent a transaction that user 112 performed while traveling through an area outside of its normal routine.

The first region 202 comprises a third region 210 that encompasses a first subset of the plurality of points in region 202. The third region 210 may represent the area surrounding where user 112 lives. The first region 202 also comprises a fourth region 212 that encompasses a second subset of the plurality of points in region 202. The fourth region 212 may represent the area surrounding where the user 112 lives. The first region 202 further comprises data points 214 and 216, which may represent areas that while in the broader region 202 where user 112 lives and works fall outside of the daily routine of the user 112. FIG. 2B provides an expanded view of the first region 202. The third region 210 comprises data points 242-256. The fourth region 212 comprises data points 226-240.

The second region 204 comprises a fifth region 220 that encompasses a first subset of the plurality of points in region 204. The fifth region 220 may represent a neighborhood of a city in which user 112 visited on vacation. The second region 204 also comprises a sixth region 222 that encompasses a second subset of the plurality of points in region 204. The sixth region 222 may represent a second neighborhood in a city in which user 112 visited on vacation. The second region 220 further comprises data point 224, which may represent the airport in the city in which user 112 visited on vacation. FIG. 2C provides an expanded view of the second region 204. The fifth region 220 comprises data points 268-276. Each of the points in region 220 include a date and time at which the user 112 visited the geospatial coordinates that are represented by the data point. While only illustrated for the points in region 220, each point in the geospatial grid 200 may also comprise a date and time at which the user 112 visited the location represented by that data point. The sixth region 222 comprises data points 260-266.

The regions 210 and 212 within region 202 and regions 220 and 222 within region 204 illustrate how the warning server 102 creates a multi-level geospatial grid 200 for each user 112. While FIG. 2 only illustrates this capability at two levels of granularity, the warning server 102 may create further subregions within the illustrated subregions. The warning server 102 defines a region based on the proximity of the data points. The operator of warning server 102 can define how close or distant points must be for inclusion in a region. For example, the operator of server 102 may program the warning server 102 to define regions based on points being within a specific number of blocks from each other, a specific number of feet from each other, a specific number of kilometers from each other, etc. The operator of warning server 102 may similarly define the outer boundaries of a region. For example, the operator of warning server 102 may program the warning server 102 to set the outer boundary of a region to a specific distance extending beyond the perimeter defined by outermost points of the region.

### Alert Generation (FIG. 3)

FIG. 3 is a flowchart of an example method 300 for warning about security breaches using an example warning system 100. The method 300 may be performed by a warning server 102 is described above. Specifically, the steps of method 300 described below are performed by the alert generation engine 124. Reference will be made to FIGS. 2A-C to better illustrate the steps of the method 300. At step 302 an alert server 102 receives a transaction comprising a pair of latitude and longitude coordinates 303 for where a transaction is being attempted by the user. For example, the latitude and longitude coordinates 303 may be received from a card reader at which a user 112 swiped a debit card. Proceeding to step 304, the alert server 102 then determines that the location where the transaction request originated is outside of the regions in the geospatial grid. For example, the warning server 102 may determine that latitude and longitude coordinates 303 in FIG. 2A are outside of the first region 202 and outside of a second region 204. The method 300 then proceeds to step 306 where the warning server 102 tags the transaction request as anomalous.

At step 308 the warning server 102 then generates an alert 162 requesting that the user confirm whether the transaction should be authenticated. Warning server 102 then transmits the alert 162 to a first user device 104 identified in the user account profile 124. Next, at step 310, the warning server 102 determines whether a response was received from the user 112. The warning server 102 may be configured to wait for a predetermined time window to make this determination. If a response is received, then the warning server 102 proceeds to step 312 and takes action (i.e., authenticates or denies the transaction) as instructed by the user 112 in the response.

If, however, a response is not received at step 310, then the warning server 102 proceeds to step 314 where it determines whether the total number of alerts 162 generated by warning server 102 for that transaction exceeds a threshold. This threshold may be configured by the operator of warning server 102 or by the user 112. The warning server 102 proceeds to step 316 if the maximum number of alerts has been exceeded, and it declines the requested transaction. If, however, the maximum number of alerts has not been exceeded, then the warning server 102 proceeds to step 318 where it resends the alert 162 to a second device 104 listed in the user account profile 124 of the user 112. The user 112 may configured its user account profile 124 to prioritize specific user devices 104 and to format the alerts 162 differently for different user devices 104. After the alert 162 is sent to the second device 104, the warning server 102 proceeds to step 310 and continues the method 300 as previously described until it reaches the end of the operational flow.

In some embodiments, the warning server 102 is further configured to receive a second transaction request, comprising a pair of latitude and longitude coordinates 305, pictured in FIG. 2B, for where a second transaction is being attempted by the user. The warning server 102 then determines that the latitude and longitude coordinates 305 from the transaction request are inside the first region 202 but outside of a third region 210 and a fourth region 212. The warning server 102 is then configured to tag the second transaction request as anomalous. The server 102 then generates an alert 162 requesting that the user 112 confirm whether the second transaction should be authenticated. Finally, the warning server 102 transmits the alert 112 to the first user device 104 identified in the user account profile 124. In yet other embodiments, the warning server 102 is configured to receive a third transaction request, comprising a pair of latitude and longitude coordinates 307, pictured in FIG. 2C, for where a third transaction is being attempted by the user. The data point 307 also includes a date and time for when the third transaction was initiated. The warning server 102 then determines that the latitude and longitude coordinates 307 from the third transaction request are within the second region 204, and that the amount of time between when the third transaction was initiated and the date and time when the user visited the most recent point (e.g., data point 274) in the second region 204 exceeds a threshold. For example, the threshold might be set at one month. The latitude and longitude coordinates 307 were generated at 10:10 am on 2/13/2020 while the most recent data point from user 112 was 2/13/2019, over a month before the third transaction request occurred. The warning server 102 is then configured to tag the transaction request as anomalous. It then generates an alert 162 requesting that the user 112 confirm whether the third transaction should be authenticated. Finally, the warning server 102 transmits the third alert 162 to the first user device 104 identified in the user account profile 124.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus for warning about security breaches, comprising:
a memory configured to store:
a geospatial grid profile for a user, comprising:
a first region comprising a first plurality of points, each point comprising latitude and longitude coordinates for a different location where the user visited;
a second region comprising a second plurality of points, each point comprising latitude and longitude coordinates for a different location where the user visited, and wherein the second region does not overlap the first region;
a user account profile comprising an identifier of a first user device for receiving alerts;
a hardware processor communicatively coupled to the memory and configured to:
receive a transaction request comprising a pair of latitude and longitude coordinates for where a transaction is being attempted by the user;
determine that the latitude and longitude coordinates from the transaction request are outside of the first and second regions;
tag the transaction request as anomalous;
generate an alert requesting that the user confirm whether the transaction should be authenticated;
transmit the alert to the first user device identified in the user account profile.

2. The apparatus of claim 1, wherein:
the first region further comprises:
a third region comprising a first subset of the first plurality of points;
a fourth region comprising a second subset of the first plurality of points, wherein the fourth region does not overlap the third region; and
the hardware processor is further configured to:
receive a second transaction request, comprising a pair of latitude and longitude coordinates for where a second transaction is being attempted by the user;
determine that the latitude and longitude coordinates from the second transaction request are inside the first region but outside of the third and fourth regions;
tag the second transaction request as anomalous;
generate a second alert requesting that the user confirm whether the second transaction should be authenticated;
transmit the second alert to the first user device identified in the user account profile.

3. The apparatus of claim 2, wherein:
the geospatial grid profile comprises, for each point, a time at which the user visited that location; and
the hardware processor is further configured to:
receive a third transaction request, comprising:
a pair of latitude and longitude coordinates for where a third transaction is being attempted by the user;
a date and time for when the third transaction was initiated;
determine that the latitude and longitude coordinates from the third transaction request are within the second region, and that the amount of time between when the third transaction was initiated and the date and time of the most recent point in the second region exceeds a threshold;
tag the transaction request as anomalous;
generate a third alert requesting that the user confirm whether the third transaction should be authenticated;
transmit the third alert to the first user device identified in the user account profile.

4. The apparatus of claim 1, wherein the hardware processor is further configured to:
receive a response from the user within a predetermined time window;
authenticate or deny the transaction as instructed in the response.

5. The apparatus of claim 1, wherein the hardware processor is further configured to:
allow a predetermined time window to elapse without receiving a response from the user;
determine that the total number of alerts related to this transaction exceeds a threshold; and
decline the transaction.

6. The apparatus of claim 1, wherein:
the user account profile further comprises:
an identifier of a second user device for receiving alerts;
an indication of the preferred format for delivering an alert to the second user device; and
the hardware processor is further configured to:
allow a predetermined time window to elapse without receiving a response from the user;
determine that the total number of alerts related to this transaction does not exceed a threshold;
generate, in the preferred format indicated in the user account profile for the second user device, a second alert requesting that the user confirm whether the transaction should be authenticated;
transmit the second alert to the second user device identified in the user account profile.

7. The apparatus of claim 3, wherein:
the user account profile further comprises an indication of a preferred format for delivering an alert to the first user device; and
the alerts are generated in the preferred format indicated in the user account profile.

8. A method for warning about security breaches, comprising:
receiving a transaction request comprising a pair of latitude and longitude coordinates for where a transaction is being attempted by the user;
determining that the latitude and longitude coordinates from the transaction request are outside of a first region comprising a first plurality of points, and outside of a second region comprising a second plurality of points, each point in the first and second regions comprising latitude and longitude coordinates for a different location where the user visited, and wherein the second region does not overlap the first region;
tagging the transaction request as anomalous;
generating an alert requesting that the user confirm whether the transaction should be authenticated;
transmitting the alert to a first user device identified in a user account profile.

9. The method of claim 8, further comprising:
receiving a second transaction request, comprising a pair of latitude and longitude coordinates for where a second transaction is being attempted by the user;
determining that the latitude and longitude coordinates from the transaction request are inside the first region but outside of a third and a fourth region, wherein:
the third and fourth regions are inside the first region;
the third region comprises a first subset of the first plurality of points;
the fourth region comprises a second subset of the first plurality of points, wherein the fourth region does not overlap the third region;
tagging the second transaction request as anomalous;
generating a second alert requesting that the user confirm whether the second transaction should be authenticated;
transmitting the second alert to the first user device identified in the user account profile.

10. The method of claim 9, further comprising:
receiving a third transaction request, comprising:
a pair of latitude and longitude coordinates for where a third transaction is being attempted by the user;
a date and time for when the third transaction was initiated;
determining that the latitude and longitude coordinates from the third transaction request are within the second region, and that the amount of time between when the third transaction was initiated and the date and time when the user visited the most recent point in the second region exceeds a threshold;
tagging the transaction request as anomalous;
generating a third alert requesting that the user confirm whether the third transaction should be authenticated;
transmitting the third alert to the first user device identified in the user account profile.

11. The method of claim 8, further comprising:
receiving a response from the user within a predetermined time window;
authenticating or denying the transaction as instructed in the response.

12. The method of claim 8, further comprising:
allowing a predetermined time window to elapse without receiving a response from the user;
determining that the total number of alerts related to this transaction exceeds a threshold;
declining the transaction.

13. The method of claim 8, further comprising:
allowing a predetermined time window to elapse without receiving a response from the user;
determining that the total number of alerts related to this transaction does not exceed a threshold;
generating, in a format that the user account profile indicates as preferred for a second user device, a second alert requesting that the user confirm whether the transaction should be authenticated;
transmitting the second alert to the second user device identified in the user account profile.

14. The method of claim 10, wherein the alerts are generated in a format indicated as preferred in the user account profile.

15. A non-transitory computer-readable medium comprising instructions that, when executed by a hardware processor, are configured to:
receive a transaction request comprising a pair of latitude and longitude coordinates for where a transaction is being attempted by the user;
determine that the latitude and longitude coordinates from the transaction request are outside of a first region comprising a first plurality of points, and outside of a second region comprising a second plurality of points, each point in the first and second regions comprising latitude and longitude coordinates for a different location where the user visited, wherein the second region does not overlap the first region;
tag the transaction request as anomalous;
generate an alert requesting that the user confirm whether the transaction should be authenticated;
transmit the alert to a first user device identified in a user account profile.

16. The non-transitory computer-readable medium of claim 15, further comprising instructions that, when executed by the hardware processor, are configured to:
receive a second transaction request, comprising a pair of latitude and longitude coordinates for where a second transaction is being attempted by the user;
determine that the latitude and longitude coordinates from the transaction request are inside the first region but outside of a third and a fourth region, wherein:
the third and fourth regions are inside the first region;
the third region comprises a first subset of the first plurality of points;
the fourth region comprises a second subset of the first plurality of points, wherein the fourth region does not overlap the third region;
tagging the second transaction request as anomalous;
generate a second alert requesting that the user confirm whether the second transaction should be authenticated;
transmit the second alert to the first user device identified in the user account profile.

17. The non-transitory computer-readable medium of claim 16, further comprising instructions that, when executed by the hardware processor, are configured to:
receive a third transaction request, comprising:
a pair of latitude and longitude coordinates for where a third transaction is being attempted by the user;
a date and time for when the third transaction was initiated;
determine that the latitude and longitude coordinates from the third transaction request are within the second region, and that the amount of time between when the third transaction was initiated and the date and time when the user visited the most recent point in the second region exceeds a threshold;
tag the transaction request as anomalous;
generate a third alert requesting that the user confirm whether the third transaction should be authenticated;
transmit the third alert to the first user device identified in the user account profile.

18. The non-transitory computer-readable medium of claim 15, further comprising instructions that, when executed by the hardware processor, are configured to:
receive a response from the user within a predetermined time window;
authenticate or deny the transaction as instructed in the response.

19. The non-transitory computer-readable medium of claim 15, further comprising instructions that, when executed by the hardware processor, are configured to:
allow a predetermined time window to elapse without receiving a response from the user;
determine that the total number of alerts related to this transaction exceeds a threshold;
decline the transaction.

20. The non-transitory computer-readable medium of claim 15, further comprising instructions that, when executed by the hardware processor, are configured to:
allow a predetermined time window to elapse without receiving a response from the user;
determine that the total number of alerts related to this transaction does not exceed a threshold;
generate, in a format that the user account profile indicates as preferred for a second user device, a second alert requesting that the user confirm whether the transaction should be authenticated;
transmit the second alert to the second user device identified in the user account profile.
